(19) United States
(12) Patent Application Publication
(10) Pub. No.: US 2011/0290388 A1
(43) Pub. Date: Dec. 1, 2011

(54) TIRE WITH SIDE FEATURES FOR RESISTING IRREGULAR SHOULDER WEAR

(76) Inventor: Robert C. Radulescu, Simpsonville, SC (US)

(21) Appl. No.: 12/302,033

(22) PCT Filed: Jul. 13, 2006
(86) PCT No.: PCT/US06/27346

§ 371 Date: Jun. 22, 2011

(51) Int. Cl. B60C 11/24

(52) U.S. Cl. 152/154.2

(57) ABSTRACT

A tire is provided having features on the side of the tire that provide improved protection against irregular wear. More specifically, apertures provided at certain depths, densities, and locations along the side of the tire can provide for improved wear patterns, including a decrease in irregular shoulder wear, particularly in regional applications. The apertures can be constructed as holes or incisions in various shapes and combinations.

### TECHNICAL FIELD OF THE INVENTION

The present invention relates to a tire having features on the side of the tire that provide improved protection against irregular wear. More specifically, apertures provided at certain depths, densities, and locations along the side of the tire provide for improved wear patterns, including a decrease in irregular shoulder wear, particularly in regional applications. The apertures can be constructed as holes or incisions in various shapes and combinations.

### BACKGROUND OF THE INVENTION

Tires, particularly commercial vehicle tires as used on trucks, must be periodically removed from service and replaced as the tires eventually wear from use. Depending upon the application and maintenance of each tire, anomalies in the tread region can also develop during use that lead to the tire being removed from service before reaching the normal useful life of the tread. Typically, such anomalies are discovered as the driver senses a change in the ride of the vehicle or a change in the tire noise during vehicle use, and removal of a tire having anomalies is frequently a subjective determination. Such anomalies can include, for example, depressions or uneven wear in the tread region, which is generally caused by unequal stress distribution laterally across the tread region. These stresses are frequently highest at the shoulder region of the tire, which in turn leads to anomalies such as irregular wear along the shoulder.

The removal of a tire due to irregular shoulder wear is generally premature as compared to those portions of the tire not having any anomalies. More specifically, other portions of the tire are frequently capable of substantial additional service. For that reason, extending the time until onset of irregular shoulder wear or decreasing the severity of such wear once it appears may result in a substantial increase in the life of the tire. For commercial vehicles such as trucks, the extension of tire life can result in significant savings by reducing the costs of purchase and installation of new or retread tires.

Efficient solutions have been developed for improving tire resistance to irregular shoulder wear. By way of example, tires have been provided with a sacrificial rib along the shoulder as shown in, for example, U.S. Pat. No. 6,488,064. Tires have also been provided with sipes along the edges of the ribs as shown in, for example, U.S. Pat. No. 6,196,288.

Previous solutions for irregular shoulder wear have been most effective when applied to tires used for long-haul applications. Unfortunately, in regional and on-off road applications, the tires frequently encounter more severe or larger lateral forces, which can tear the previously mentioned features. For these applications, an even more robust solution is desired for resisting irregular shoulder wear. More specifically, a tire capable of exhibiting more uniform wear in these more extreme applications is desired.

### SUMMARY OF EXEMPLARY EMBODIMENTS OF THE INVENTION

Objects and advantages of the invention will be set forth in part in the following description, or may be obvious from the description, or may be learned through practice of the invention. A summary of certain exemplary embodiments of the present invention will now be discussed.

In one exemplary embodiment, a tire is provided that defines axial, radial, and circumferential directions. The tire includes a pair of shoulders with one shoulder located on each side of the tire. A tread region includes tread sculptures and defines a wearable tread depth. A plurality of openings are positioned circumferentially along at least one of the pair of shoulders and are located at radial positions generally near or below the wearable tread depth. The plurality of openings has a length that is in the range of about 3 mm to about 15 mm. The openings define a total void area. The total void area A in units of millimeters squared is a function of a variable parameter A₀, having units of millimeters, and a radius r which is the average radial position of the openings as measured in millimeters from the axis of rotation of the tire. That is to say A=A₀(π)(r), where A₀ is in the range of about 2 (mm) to about 10 (mm). Preferably, the plurality of openings is located at radial positions in a range between generally at about 2/3 of the wearable tread depth to about 5/3 of the wearable tread depth. In addition, it is preferable that the openings be located at distance of 2 mm from each other with such distance being measured from the outer edge of adjacent openings. The openings may take on a variety of shapes including, but not limited to, circular, oval, elliptical, and rectilinear. In a preferred embodiment, the plurality of openings has a length in the range of about 10 mm to about 12 mm. In still another preferred embodiment, the plurality of axially-oriented holes define a total void area where the variable parameter A₀ is in the range of about 2 (mm) to about 5 (mm).

In still another exemplary embodiment of the present invention, a tire is provided with axial, radial, and circumferential directions defined. The tire includes a pair of shoulders where one shoulder is located on each side of the tire. A tread region is defined and includes tread features having a wearable tread depth. A plurality of axially-oriented holes are positioned circumferentially along at least one of the pair of shoulders and are located at radial positions generally near or below the wearable tread depth. The plurality of axially-oriented holes each has a length that is in the range of about 3 mm to about 15 mm. The holes define a total void area A=A₀(π)(r), where the variable parameter A₀ is in the range of about 2 (mm) to about 5 (mm), and where r is the average radial position of the holes as measured in millimeters from the axis of the tire. Additional modifications of this exemplary embodiment as described herein fall within the scope of the claims below.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a side view of a tire section constructed according to an exemplary embodiment of the invention.

FIG. 2 illustrates a cross-section of one shoulder of the exemplary embodiment of FIG. 1.

FIG. 3 is an illustration of certain experimental data as will be discussed herein.

FIGS. 4 and 5 each provide tire sections constructed according to additional exemplary embodiments of the present invention.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

As used herein, the following terms have these definitions:

The term “radial” refers to the direction perpendicular to the axis of rotation of the tire.

The term “axial” refers to the direction parallel to the axis of rotation of the tire.

The term “circumferential” refers to the circular direction defined by a radius of fixed length as it is rotated about the axis of rotation of the tire.

The term “tread strip” refers to that portion of a tire intended for contact with a support surface.

The terms “tread sculpture” or “tread feature” refer to structures projecting from the “tread strip” and may include, for example, ribs which are formed continuously about the circumference of the tire, a plurality of blocks which are arranged about the circumference of the tire, and both ribs and blocks.

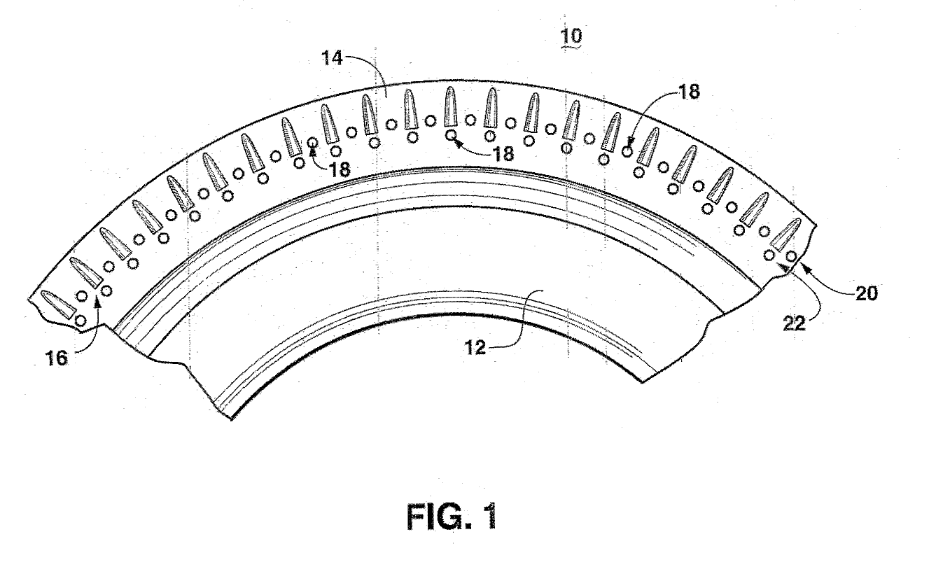

An exemplary embodiment of a tire 10 according to the present invention is illustrated in FIG. 1. Tire 10 includes sidewall 12, tread region 14, and tire shoulder 16. Along shoulder 16, tire 10 has been provided with numerous round holes 18 that are evenly spaced over shoulder 16 along the circumferential direction. While applicant has tested the alternating pattern of holes 18 created by rows 20 and 22 as shown in FIG. 1, it should be understood that a variety of different patterns may be used and this particular pattern is by way of example only. Furthermore, while only one side of tire 10 is illustrated, holes 18 are provided on both sides—i.e. both shoulders—of tire 10. However, it should be understood that while holes 18 are described as being on both shoulders of tire 10 for this particular exemplary embodiment, the present invention includes embodiments where holes or apertures are placed only along one shoulder of a tire. Such an arrangement may be preferable in some applications.

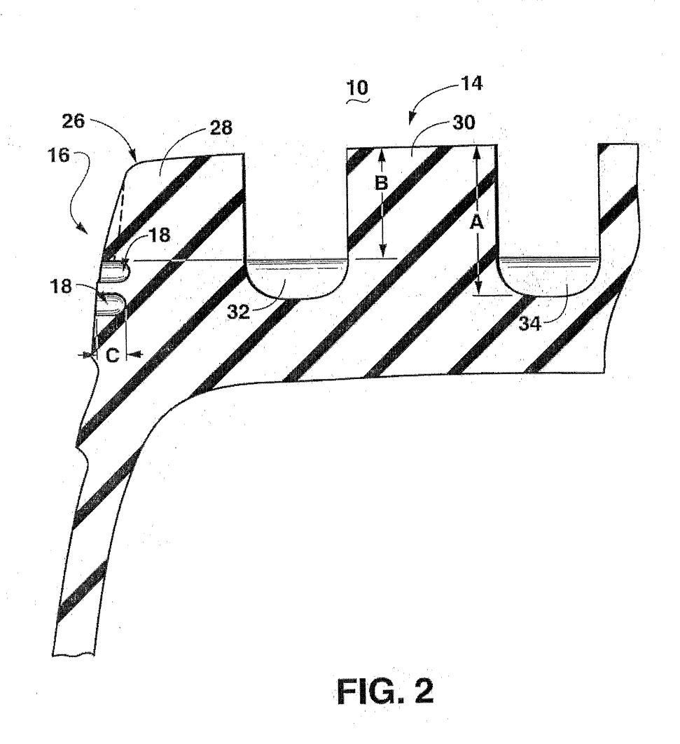

FIG. 2 provides a cross section and magnified view of the tread region 14 and tire shoulder 16 in FIG. 1. As shown, holes 18 are formed into shoulder 16 and are open to the exterior along shoulder 16. Without holes 18, under large lateral forces, the exterior surface 26 of shoulder rib 28 will wear more than other parts of the tread region 14 of tire 10. With such wear, a rounder tire profile can occur that will gradually become even more braking. Eventually, overall depressions that are localized on shoulder rib 28—i.e. irregular shoulder wear—will take place. Applicant has determined that the addition of holes 18 lessens the rigidity of tire 10 along shoulder rib 28, which causes the wear across tread region 14 to be more uniform. While tire 10 may wear more quickly overall, such wear will occur more evenly depending upon the density, length, and position of the holes 18 as will be discussed.

Certain advantages of the present invention appear in measurements of wear conducted during testing of an exemplary embodiment of the present invention that was constructed in a manner similar to FIG. 1. More specifically, applicant compared the performance of tires 10 having holes 18 with witness tires lacking holes 18. Truck tires of a size 275/80 R 22.5, with and without holes 18, were subjected to conditions of large lateral forces such as might be encountered in regional applications. Tires were tested on both the left and right side of the vehicle.

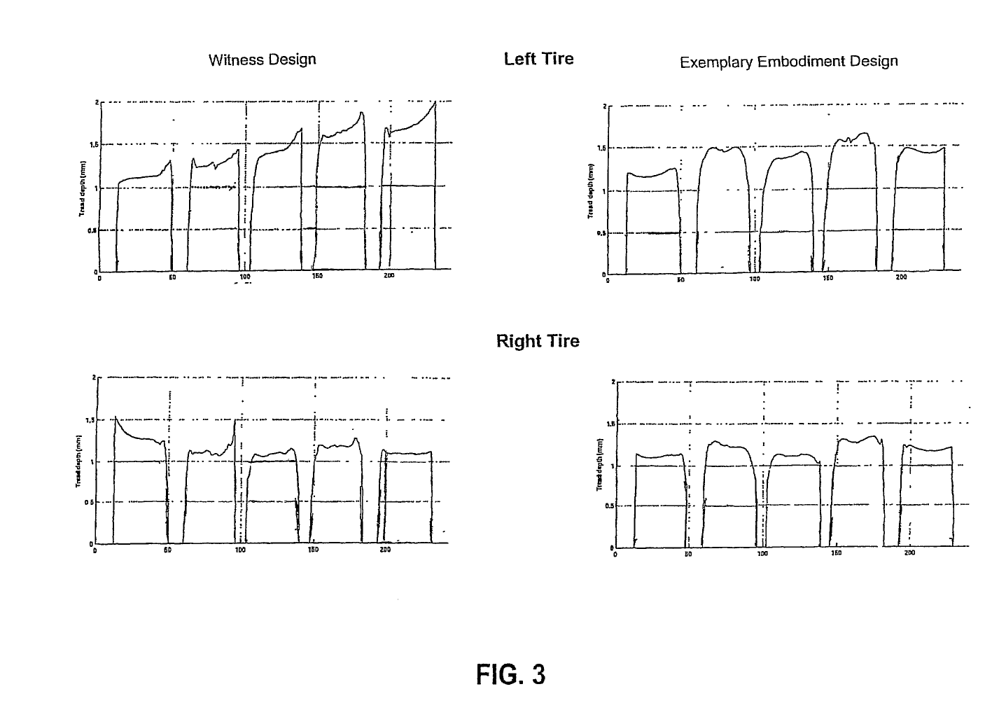

Referring now to FIG. 3, wear for the witness design is shown on the left while the wear for a tire constructed with holes 18 is shown on the right. As depicted in FIG. 3, the tires used for testing had five rows of tread features moving from the exterior (left in FIG. 3) to the interior (right in FIG. 3). Originally, all tires had a relatively uniform tread depth before testing was conducted. After testing, the witness design (on the left in FIG. 3) shows uneven wear across the tread region of the tire. For example, the left tire used in the witness design shows increasing wear across the tire from the exterior to the interior side—resulting in a non-uniform wear pattern. The right tire used in the witness design also shows non-uniform tread wear with wear increasing across the tread from the interior side to the exterior side. Both of the witness tires have a substantial amount of wear occurring along one shoulder.

In comparison, the tires constructed with holes 18 have a more uniform wear pattern for the both left and right tires. More specifically, wear does not necessarily increase in either direction across the tread of the tire and overall a more even wear pattern is obtained. While overall wear has increased to some extent, this is a more preferable result than the non-uniform wear occurring with the witness tire. As a result, the tires with holes 18 will last longer in service and use more of the overall tread than the witness tires, which would likely be replaced much sooner due to differences in ride and/or sound associated with the irregular shoulder wear.

Applicant has also determined holes 18 should meet certain requirements to increase effectiveness. Referring to FIG. 2, arrow A designates the total depth of tread sculpture 30 while arrow B designates the “wearable tread depth” of tread sculpture 30. More specifically, “wearable tread depth” represents the depth of tread sculpture 30 that may be used before wear begins to occur on tread wear bars 32 and 34, which indicate when tire 10 should be replaced. Holes 18 should be placed at a radial position that is either generally at about 2/3 of the wearable tread depth or below the wearable tread depth B. However, holes 18 should not be located at a distance greater than about 5/3 of the total tread depth A from surface 26. Placed outside these general limits, applicant believes holes 18 may either become ineffective or can undesirably generate irregular wear. While the length or axis of holes 18 may be oriented in a manner that is generally parallel to the exterior surface 26, for manufacturing reasons holes 18 are preferably oriented in a manner that is generally parallel to the axis of rotation of tire 10. It should be understood that the axis of the holes 18 need not be perfectly parallel to the axis of the tire. Rather, the axis of holes 18 should be “generally parallel” to the axis of rotation or “axially-oriented”, and these terms as used here and in the claims that follow should each be understood to include a range from perfectly parallel to an angle of about plus or minus 10 degrees relative to the axis of rotation of tire 10.

In addition, to maximize effectiveness in currently used commercial tires sizes, holes 18 should have a depth C that is between about 3 mm and about 15 mm. Outside of this general range, the effect of holes 18 in decreasing irregular wear either becomes ineffective or achieves adverse wear patterns. The optimum depth for a particular application can be determined experimentally using the teachings disclosed herein. Preferably, for known commercial tire sizes, a depth (i.e. length) of about 10 mm to 12 mm is used.

Applicant has also determined that the cumulative void in surface area created by all holes 18 along one shoulder 16, referred to herein as “total void area”, can be defined as A=A₀(π)(r), where the variable parameter A₀ should be in the range of about 2 (mm) to about 10 (mm), and where r is the average radial position of the holes as measured in millimeters from the axis of the tire. Again, outside this general range, the effect of holes 18 becomes minimal or begins to affect wear adversely. Preferably, the total void area has a variable parameter A₀ in the range of about 2 (mm) to about 5 (mm). The void area for individual holes 18 ideally should be in the range of about 3 mm² to about 30 mm². Again, in a preferred embodiment, the void area for individual holes 18 should be in the range of about 5 mm² to about 15 mm².

The placement of the holes relative to one another can also impact the ability to resist irregular shoulder wear. Applicant has determined that a minimum distance of about 2 mm should be used—as measured along shoulder 16 between the outer edges of holes 18. Preferably, a distance of between about 3 mm to about 6 mm should be used. Although a perfect distribution is not required, preferably holes 18 are distributed uniformly over shoulder 16 with the distance between the centers of successive holes 18 (when projected onto a circle with average radius r) not exceeding 20 mm.

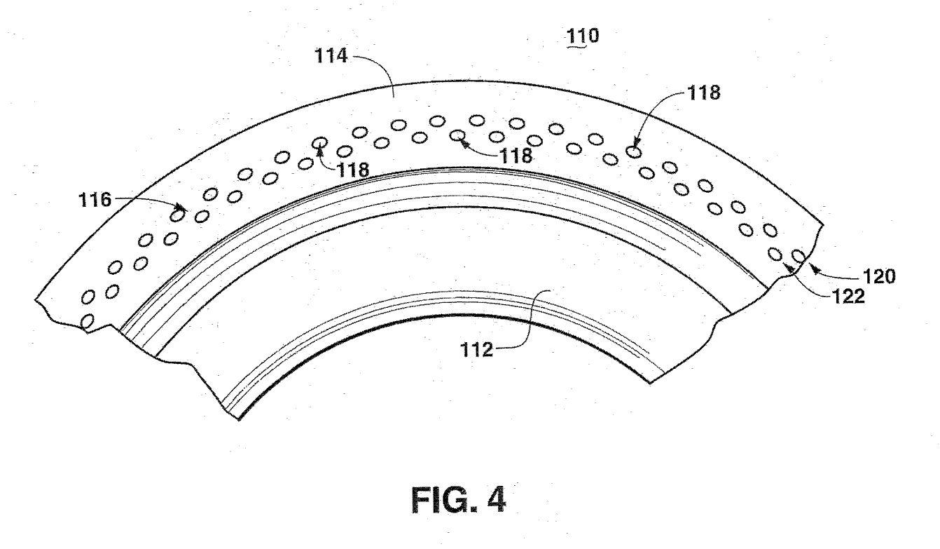

FIG. 4 illustrates another exemplary embodiment of the present invention with reference numerals representing features the same or similar to that described above. As shown, holes 118 are elliptical in shape but are otherwise configured as described above with regard to holes 18. As previously stated, holes 118 need not be arranged in the alternating pattern of rows 120 and 122; other patterns may be used.

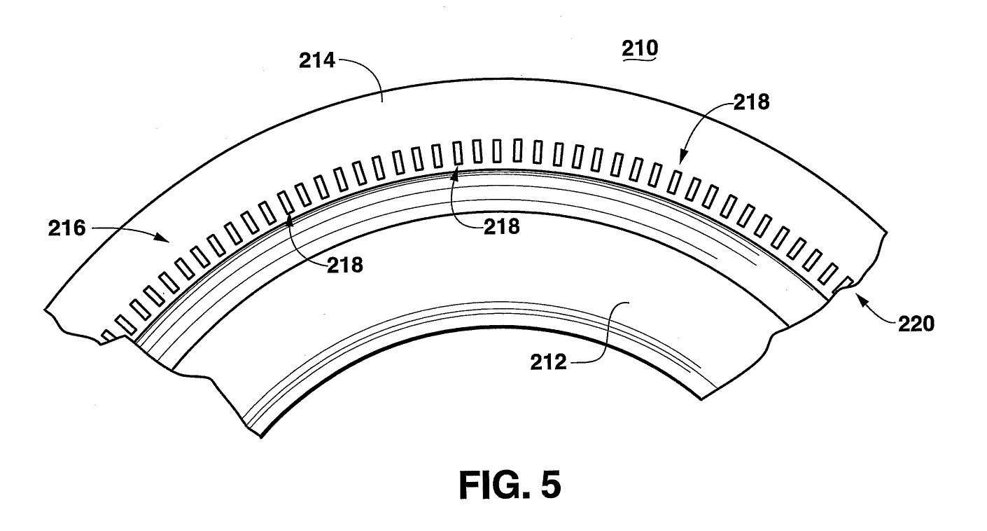

It should be understood that the present invention includes various other modifications that can be made to the exemplary embodiments described herein that come within the scope of the appended claims and their equivalents. By way of example only, FIG. 5 illustrates another exemplary embodiment of the present invention in which the openings are created by numerous slots or thin incisions 218 that improve the resistance of tire 210 to irregular shoulder wear. Using the teachings disclosed herein, it will be understood that a variety of different shapes could be used to create openings along the shoulders of a tire that lessen the rigidity so as to provide for a more uniform wear across the tread. These and other embodiments of the present invention are with the spirit and scope of the claims that now follow.

What is claimed is:

1. A tire defining axial, radial, and circumferential directions and comprising:
a pair of shoulders where one shoulder is located on each side of the tire;
a tread region including tread features defining a wearable tread depth;
a plurality of axially-oriented holes positioned circumferentially along at least one of said shoulders and located at radial positions generally near or below the wearable tread depth;
said plurality of axially-oriented holes each having a length that is in the range of about 3 mm to about 15 mm, said holes defining a total void area that is in the range of about 2 (mm)(π)(r) to about 10 (mm)(π)(r), where r is the average radial position of said holes as measured in millimeters from the axis of the tire.

2. A tire as in claim 1, wherein said plurality of axially-oriented holes are located at radial positions in a range between generally at about 2/3 of the wearable tread depth to about 5/3 of the wearable tread depth.

3. A tire as in claim 1, wherein each of said plurality of axially-oriented holes has an outer edge, and wherein the outer edge of each said hole is at least about 2 mm from the outer edge of any adjacent said hole.

4. A tire as in claim 1, wherein said plurality of axially-oriented holes are elliptical in shape.

5. A tire as in claim 1, 2, 3, or 4, wherein said plurality of axially-oriented holes have a length in the range of about 10 mm to about 12 mm.

6. A tire as in claim 1, 2, 3, or 4, wherein said plurality of axially-oriented holes define a total void area that is in the range of about 2 (mm)(π)(r) to about 5 (mm)(πn)(r).

7. A tire having axial, radial, and circumferential directions and comprising:
a pair of shoulders with one shoulder located on each side of the tire;
a tread region including tread sculptures that define a wearable tread depth;
a plurality of openings positioned circumferentially along at least one of said shoulders and located at radial positions generally near or below the wearable tread depth, said plurality of openings having a length that is in the range of about 3 mm to about 15 mm, said openings defining a total void area that is in the range of about 2 (mm)(π)(r) to about 10 (mm)(π)(r), where r is the average radial position of said openings as measured in millimeters from the axis of the tire.

8. A tire as in claim 7, wherein said plurality of openings are located at radial positions in a range between generally at about 2/3 of the wearable tread depth to about 5/3 of the wearable tread depth.

9. A tire as in claim 7, wherein each of said plurality of openings has an outer edge, and wherein the outer edge of each said opening is at least about 2 mm from the outer edge of any adjacent said opening.

10. A tire as in claim 7, wherein said plurality of openings are rectilinear in shape.

11. A tire as in claim 7, wherein the individual void area for each of said plurality of openings is in the range of about 3 mm² to about 30 mm².

12. A tire as in claim 7, 8, 9, 10, or 11, wherein said plurality of openings have a length in the range of about 10 mm to about 12 mm.

13. A tire as in claim 7, 8, 9, 10, or 11, wherein said plurality of openings define a total void area that is in the range of about 2 (mm)(π)(r) to about 5 (mm)(π)(r).
